(19) United States
(12) Patent Application Publication
(10) Pub. No.: US 2026/0044491 A1
(43) Pub. Date: Feb. 12, 2026

(54) METHODS AND SYSTEMS FOR ENHANCED GENEALOGY CONNECTIONS

(71) Applicant: Treemily Group Inc., Brooklyn, NY (US)

(72) Inventor: Asher Halberstam, Brooklyn, NY (US)

(21) Appl. No.: 19/290,137

(22) Filed: Aug. 4, 2025

Related U.S. Application Data
(60) Provisional application No. 63/681,559, filed on Aug. 9, 2024.

(51) Int. Cl. G06F 16/23

(52) U.S. Cl. CPC G06F 16/2379

(57) ABSTRACT

A genealogy system includes improved systems and methods to find and merge highly accurate matching relations despite altered or incomplete information in available data sources. The improved systems and methods may include selecting a stored family tree for matching analysis; selecting a person from the stored family tree and information associated with the person for matching analysis; creating indexing information for the person for the matching analysis; comparing indexing information for the person against indexing information for one or more other persons from other stored family trees for matching analysis; determining one or more potential matching persons from other family trees that meet threshold matching qualifications to modify the selected stored family tree; providing the user with the one or more potential matching persons to select for updating the stored family tree; updating the stored family tree with any selected potential matching persons that the user selected.

### CROSS REFERENCE TO RELATED APPLICATION

This application is a Nonprovisional of U.S. Provisional Application No. 63/681,559, filed Aug. 9, 2024, the contents of which are hereby incorporated by reference.

### FIELD OF THE DISCLOSURE

Implementations of the disclosure relate to enhancements in genealogy searching systems, providing enhanced functionality and technical improvements over existing genealogy computing systems.

### BACKGROUND

Finding relevant genealogical records to build and update a family tree is extremely challenging. The type and quality of genealogy data available can vary greatly. As people move from county to country, spellings for information associated with people may be altered to confirm to local customs, translations, or because original spellings can be altered due to mistakes. For example, the spelling of names of people and places can be misspelled or be phonetically changed. People lose connections to their relatives and may have incomplete data records to build out their family trees.

Existing genealogy systems typically allow users to create and store family trees manually, inputting information about family members and relationships. Users can view and edit these family trees, but the process of identifying potential matches with other family trees is often cumbersome and time-consuming. Some systems may offer limited automated matching capabilities based on predefined criteria, but these approaches may not provide comprehensive or accurate results due to the complexity and variability of genealogical data.

In traditional genealogy systems, users are required to manually search for potential matches across multiple family trees, relying on their own judgment and knowledge to determine the relevance and accuracy of the matches. This manual matching process can be inefficient and prone to errors, leading to missed connections or incorrect updates to family trees. Additionally, the lack of advanced indexing methods and matching algorithms specific to genealogy in existing systems can further hinder the accuracy and efficiency of identifying relevant potential matches between family trees. Moreover, the volume of available genealogy records is also too vast to search through for existing computing systems. Existing computing systems cannot efficiently search through all records for matches quickly enough to provide timely matches to users. It can take several days for a computing system to perform name by name matches of genealogy records. This is further compounded when a genealogy system is supporting many users (e.g., thousands, hundreds of thousands, millions, etc.) and running millions of searches for matching genealogy records.

These limitations highlight the need for an improved method of operating a genealogy system that streamlines the computer matching analysis process, enhances the accuracy of identifying potential matches, and facilitates seamless updates to stored family trees based on selected matches.

### BRIEF SUMMARY

In some aspects, the techniques described herein relate to a method of operating a genealogy system, including: storing one or more family trees created by users; selecting a stored family tree for matching analysis; selecting a person from the stored family tree and information associated with the person for matching analysis; creating indexing information for the person for the matching analysis; comparing indexing information for the person against indexing information for one or more other persons from other stored family trees for matching analysis; determining one or more potential matching persons from other family trees that meet threshold matching qualifications to modify the selected stored family tree; providing the user with the one or more potential matching persons to select for updating the stored family tree; updating the stored family tree with any selected potential matching persons that the user selected; and transmitting, to a remote client, an updated family tree based on the stored family tree.

In some aspects, the techniques described herein relate to a method of operating a genealogy system, including: storing one or more family trees created by users; selecting a family tree from the stored one or more family trees for matching analysis preparation; generating unique name tokens for at least one person in the selected family tree based on names associated with the one or more persons; generating tokenized facts mappings for at least person in the selected family tree; generating tokenized relations mapping for at least one person in the selected family tree; storing the generated unique name tokens, tokenized facts mappings, and the tokenized relations mappings for the at least one person; providing the generated unique name tokens, tokenized facts mappings, and the tokenized relations mappings for matching against at least one of a generated unique name token, tokenized facts mapping, or a tokenized relations mapping of at least one other person from a different family tree; and transmitting, to a remote client, one or more potential matching persons to select for updating the stored family tree.

In some aspects, the techniques described herein relate to a method, wherein the unique name tokens are created based on a quantity of letters in a word and a combination of one or more consonants in a word.

In some aspects, the techniques described herein relate to a method, further including creating a plurality of unique name tokens for one object associated with a person.

In some aspects, the techniques described herein relate to a method of operating a genealogy system, including: selecting a family tree from a plurality of stored family trees for matching analysis; selecting a person in the selected family tree; determining if the selected person is available for a matching analysis; determining if the selected person has an associated status of pending or hold; determining whether a quantity of prior match results for the selected person is below a predetermined threshold; determining the quantity of matches that remain available to create for the selected person; obtaining any stored prior determined match results for the selected person; removing any stored prior determined match results for the selected person that determined from the family tree; generating potential matches to other persons from other family trees for the selected person based on name tokens and generate a name score for the potential matches; generating a fact score for the potential matches based on comparing facts of the potential matches to facts associated with the selected person; generating a relationship score for the potential matches based on comparing relationships of the potential matches to relationships associated with the selected person; calculating a total score of the potential matches based on the name score, fact scores, and relationship scores for the potential matches; storing potential matches based on the total scores; determining whether there are new relations to add to the selected family tree based on the matches; and storing a predetermined quantity of matches for the selected person in the selected family tree.

In some aspects, the techniques described herein relate to a method of operating a genealogy system, including: receiving a request to open a user's family tree for display; loading stored match results for any persons in the user's family tree; transmitting the requested family tree to the user, wherein the transmitting provides an indication of at least one person in the requested family tree with at least one potential match to review; enabling the user to select the at least one person in the requested family tree with the at least one potential match for review; receiving from the user, a selection of the at least one person to review the at least one potential match; rechecking the selected at least one person and the at least one potential match to confirm that matching information is still valid; transmitting at least one of changes and additions from the at least one potential match that can be applied to the selected at least one person; determining that the user accepted the at least one potential match to update to the selected family tree; executing a merge process to update the selected family tree with the information associated with the at least one potential match; and transmitting to the user an updated selected family tree based on information associated with the at least one potential match.

In some aspects, the techniques described herein relate to a method, further including: providing a plurality of potential matches for the selected person in the selected family tree; determining that the user rejected one of the plurality of potential matches for the selected person in the selected family tree; and marking the rejected one of the plurality of potential matched to prevent the at least one potential match from being provided to the user at a future time for the selected family tree.

In some aspects, the techniques described herein relate to a method of operating a genealogy system, including: receiving a request to merge data from a first family tree to a second family tree; generating mappings for persons and families that will be updated based on the request to merge data; generating correction data for close family members for persons that will be updated in the second family tree; creating new family members in the second family tree for persons that will be updated in the second family tree; updating close family members for persons that will be updated in the second family tree; copying information from the first family tree to the second family tree for persons and families that were updated; storing the copied information with the second family tree; and transmitting an updated display of the second family tree to a remote client.

In some aspects, the techniques described herein relate to a method, further including: if a person from a first family tree that will be added to the second family tree and the person does not exist in the second family tree, creating a new entry for the person in the second family tree.

In some aspects, the techniques described herein relate to a system for operating a genealogy system including: one or more processors configured to: store one or more family trees created by users; select a stored family tree for matching analysis; select a person from the stored family tree and information associated with the person for matching analysis; create indexing information for the person for the matching analysis; compare indexing information for the person against indexing information for one or more other persons from other stored family trees for matching analysis; determine one or more potential matching persons from other family trees that meet threshold matching qualifications to modify the selected stored family tree; provide the user with the one or more potential matching persons to select for updating the stored family tree; update the stored family tree with any selected potential matching persons that the user selected; and transmit, to a remote client, an updated family tree based on the stored family tree.

In some aspects, the techniques described herein relate to a system for operating a genealogy system including: one or more processors configured to: store one or more family trees created by users; select a family tree from the stored one or more family trees for matching analysis preparation; generate unique name tokens for at least one person in the selected family tree based on names associated with the one or more persons; generate tokenized facts mappings for at least person in the selected family tree; generate tokenized relations mapping for at least one person in the selected family tree; store the generated unique name tokens, tokenized facts mappings, and the tokenized relations mappings for the at least one person; provide the generated unique name tokens, tokenized facts mappings, and the tokenized relations mappings for matching against at least one of a generated unique name token, tokenized facts mapping, or a tokenized relations mapping of at least one other person from a different family tree; and transmit, to a remote client, one or more potential matching persons to select for updating the stored family tree.

In some aspects, the techniques described herein relate to a system, wherein the unique name tokens are created based on a quantity of letters in a word and a combination of one or more consonants in a word.

In some aspects, the techniques described herein relate to a system, wherein the one or more processors are further configured to: create a plurality of unique name tokens for one object associated with a person.

In some aspects, the techniques described herein relate to a system for operating a genealogy system including: one or more processors configured to: select a family tree from a plurality of stored family trees for matching analysis; select a person in the selected family tree; determine if the selected person is available for a matching analysis; determine if the selected person has an associated status of pending or hold; determine whether a quantity of prior match results for the selected person is below a predetermined threshold; determine the quantity of matches that remain available to create for the selected person; obtain any stored prior determined match results for the selected person; remove any stored prior determined match results for the selected person that determined from the family tree; generate potential matches to other persons from other family trees for the selected person based on name tokens and generate a name score for the potential matches; generate a fact score for the potential matches based on comparing facts of the potential matches to facts associated with the selected person; generate a relationship score for the potential matches based on comparing relationship of the potential matches to relationships associated with the selected person; calculate a total score of the potential matches based on the name score, fact scores, and relationship scores for the potential matches; store potential matches based on the total scores; determine whether there are new relations to add to the selected family tree based on the matches; and store a predetermined quantity of matches for the selected person in the selected family tree.

In some aspects, the techniques described herein relate to a system for operating a genealogy system including: one or more processors configured to: receive a request to open a user's family tree for display; load stored match results for any persons in the user's family tree; transmit the requested family tree to the user, wherein the transmitting provides an indication of at least one person in the requested family tree with at least one potential match to review; enable the user to select the at least one person in the requested family tree with the at least one potential match for review; receive from the user, a selection of the at least one person to review the at least one potential match; recheck the selected at least one person and the at least one potential match to confirm that matching information is still valid; transmit at least one of changes and additions from the at least one potential match that can be applied to the selected at least one person; determine that the user accepted the at least one potential match to update to the selected family tree; execute a merge process to update the selected family tree with the information associated with the at least one potential match; and transmit to the user an updated selected family tree based on information associated with the at least one potential match.

In some aspects, the techniques described herein relate to a system, wherein the one or more processors are further configured to: provide a plurality of potential matches for the selected person in the selected family tree; determine that the user rejected one of the plurality of potential matches for the selected person in the selected family tree; and mark the rejected one of the plurality of potential matched to prevent the at least one potential match from being provided to the user at a future time for selected family tree.

In some aspects, the techniques described herein relate to a system for operating a genealogy system including: one or more processors configured to: receive a request to merge data from a first family tree to a second family tree; generate mappings for persons and families that will be updated based on the request to merge data; generate correction data for close family members for persons that will be updated in the second family tree; create new family members in the second family tree for persons that will be updated in the second family tree; update close family members for persons that will be updated in the second family tree; copy information from the first family tree to the second family tree for persons and families that were updated; store the copied information with the second family tree; and transmit an updated display of the second family tree to a remote client.

In some aspects, the techniques described herein relate to a system, wherein the one or more processors are further configured to: if a person from a first family tree that will be added to the second family tree and the person does not exist in the second family tree, create a new entry for the person in the second family tree.

### BRIEF DESCRIPTION OF THE FIGURES

FIG. 1 is a block diagram that describes an improved genealogy system according to some implementations of the present disclosure.

FIG. 2 is a flowchart of an example overview process 200 of a genealogy system that includes searching, matching, and merging of records into family trees.

FIG. 3 is a flowchart of an example process 300 for preparing information for people in a family tree for searching and matching against other people in other family trees.

FIG. 4 is a flowchart of an example process 400 of searching and matching indexed records of people in family trees in a genealogy system.

FIG. 5 is a flowchart of an example process 500 of a genealogy system providing selections for updating a family tree.

FIG. 6 is a flowchart of an example process 600 of a genealogy system merging matches into a family tree.

FIG. 7 illustrates an example computer system 700 for executing client or server operations for a genealogy system.

FIG. 8 illustrates a table of example token generation rules that can be used by the genealogy system.

### DETAILED DESCRIPTION

The systems and methods described herein provide a new and improved genealogy correction system that efficiently increases match accuracy and finds more familial relations than were previously possible in prior genealogy systems.

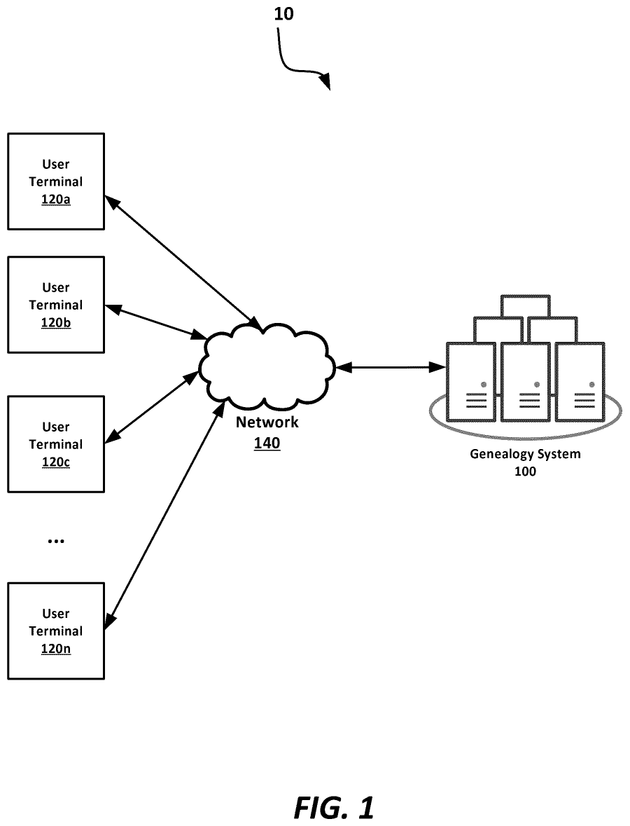

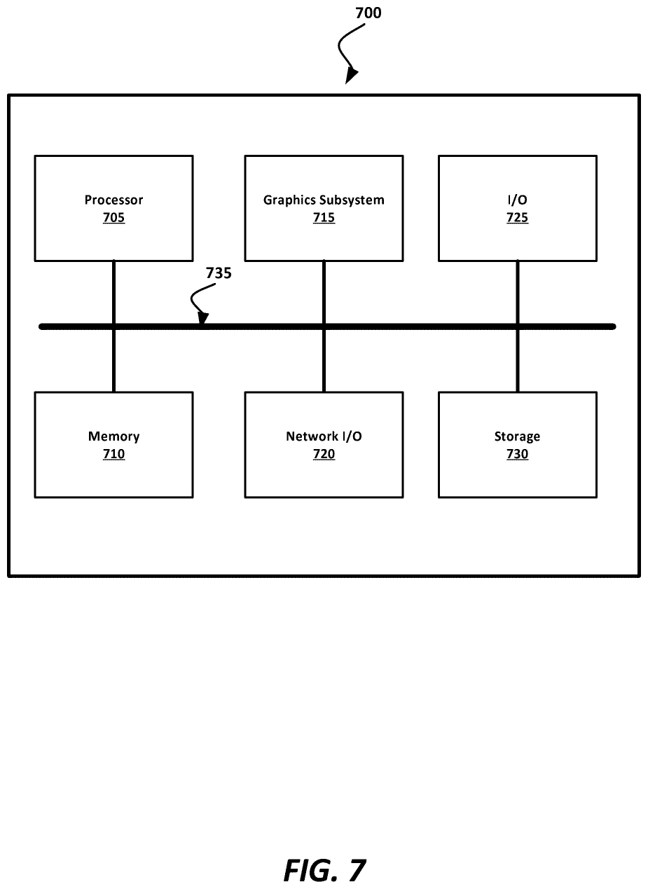

FIG. 1 is a block diagram that describes an improved system 10, according to some implementations of the present disclosure. In some implementations, system 10 may include an improved genealogy system 100. In some implementations, the genealogy system 100 may include one or more specialized servers that execute genealogy search, matching, and merging functions as described in the instant disclosure. The servers in genealogy system 100 may include computing devices, such as the computing system 700 further described in FIG. 7 and configured with specialized instructions to execute genealogy search, matching, and merging functions as described herein. In some implementations, the system 10 may include one or more user terminals, such as user terminal 120a, user terminal 120b, user terminal 120c, up through user terminal 120n. The system 10 may include any suitable number of user terminals. The user terminals in system 10 may include computing devices, such as the computing system 700 further described in FIG. 7. User terminals may be configured to send and receive data to the genealogy system 100 via network 140. Network 140 can be the Internet or one or more other suitable networks.

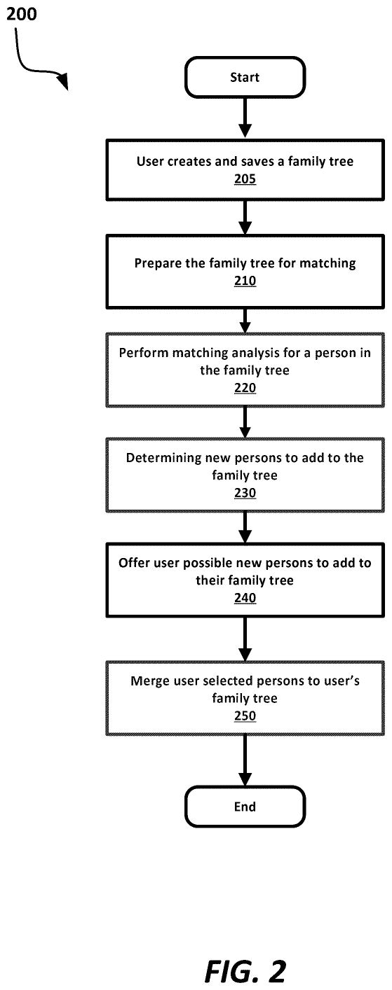

FIG. 2 is a flowchart of an example process 200 of a genealogy system that includes searching, matching, and merging of records into family trees. In some implementations, process 200 can be performed by a processor, such as a processor 705 specially programmed to execute one or more functions of process 200 in a computing system 700. In some implementations, one or more process blocks of FIG. 2 may be performed by a genealogy system such as genealogy system 100.

As shown in FIG. 2, at block 205, process 200 may include enabling a user to create and save a family tree. For example, the genealogy system 100 may store one or more family trees created by one or more users. Process 200 may include selecting a stored family tree from a plurality of stored family trees for matching analysis. As shown at block 210, process 200 may prepare the selected family tree for an improved searching and matching process that is further described herein. As will be described herein, the preparation process may include creating indexing information associated with one or more persons listed in the selected family tree. The process of creating indexing information may include creating objects that can be used in the matching process to find updates to persons in a selected family tree or new persons to add to the selected family tree. In some implementations, objects may include a person's first name, last name, gender, close relatives (e.g., parents, partners, children, siblings, parents-in-law, etc.), fact/profile information (e.g., residence, alternative names, profession, etc.). The process of creating indexing information objects may include creating one or more tokens or token groups for information associated with the one or more persons listed in the family tree. The tokens in a token group create variations of the objects such as a person's name and places associated with a person, which can be used to match against object tokens in token groups created for people listed in other family trees. As shown at block 220, process 200 may perform matching analysis for one or more persons in a family tree against one or more persons in one or more other family trees. The matching analysis may include comparing object tokens created for a person against object tokens created for other people in other family trees. The matching analysis may include matching object tokens against other object tokens (e.g., matching tokenized names to other tokenized names, matching tokenized relationships to other tokenized relationships, matching other tokenized information stored in association with persons in other family trees, etc.). The matching analysis may include generating one or more scoring factors based on the object matching analysis. As shown in block 230, the process 200 may include determining new persons to add to the selected family tree. The process 200 at block 230 may also include determining persons to update for the selected family tree. The scores determined in block 220 may determine what matches are best suited as potential matches that can be used to update the selected family tree. In some implementations, the matching criteria may include determining one or more potential matching persons from other family trees that meet threshold matching qualifications to correct or otherwise modify the selected family tree. As further shown in FIG. 2, process 200 at block 240 may include providing the user with the one or more potential matching persons to select for updating the selected family tree. For example, when a user accesses their family tree, the genealogy system may highlight or indicate that one or more persons in their family tree have potential updates or one or more new persons have been identified as possible new additions to their family tree. In some implementations, the genealogy system may send an alert to a user (e.g., an email or a text message alerting a user associated with the selected family tree with possible updates or corrections to their family tree). As also shown in FIG. 2, process 200 at block 250 may include updating the selected family tree with any selected potential matching persons that the user selected. As further shown in FIG. 2, process 200 may include transmitting to a remote client (e.g., a user terminal such as user terminal 120a) an updated family tree based on the selected family tree.

Although FIG. 2 shows example blocks of process 200, in some implementations, process 200 may include additional blocks, fewer blocks, different blocks, or differently arranged blocks than those depicted in FIG. 2. Additionally or alternatively, two or more of the blocks of process 200 may be performed in parallel.

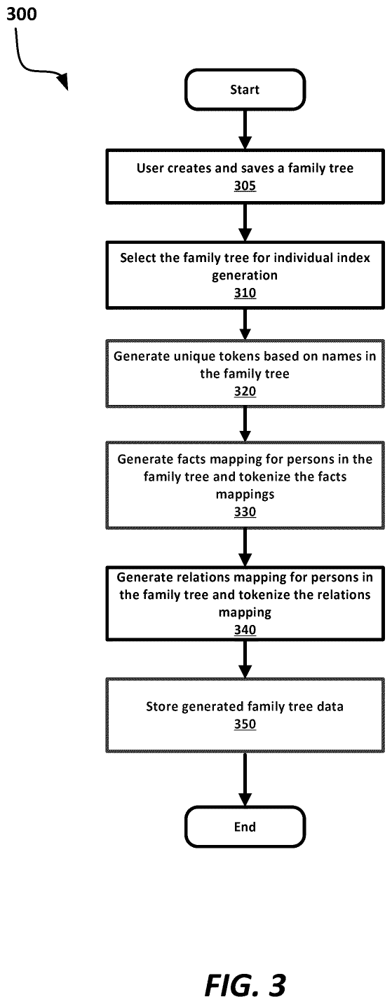

FIG. 3 is a flowchart of an example process 300 in a genealogy system for preparing information for people in a family tree for searching and matching against other people in other family trees. In some implementations, process 300 can be performed by a processor, such as a processor 705 specially programmed to execute one or more functions of process 300 in a computing system 700. In some implementations, one or more process blocks of FIG. 3 may be performed by a genealogy system, such as genealogy system 100.

As shown in FIG. 3, process 300 at block 305 may include enabling a user to create and store a family tree. It should be appreciated that a user can create and store one or more family trees. In some implementations, multiple different users can create and store one or more family trees. The more family trees that are stored in the genealogy system, the more potential matches the genealogy system can potentially create for users. It should be appreciated that the genealogy system may obtain data for searching and mapping outside of the data store for the genealogy system from any suitable data source. To create more usable data and to improve search efficiency and accuracy, the process 300 may include preparing a family tree for matching analysis. The matching analysis preparation may include creating index information associated with persons in a family tree by way of generating objects used for comparison. Generating objects may include generating tokens of words used in the creation of the family tree, such as creating name tokens, generating facts mapping objects and associated tokens for persons in the family tree, and generating relations mapping objects and associated tokens for persons in the family tree. As shown process 300 at block 310 may include selecting a family tree from the stored one or more family trees for index generation. As shown in process 300 at block 320, the indexing process may include generating unique tokens for at least one person in the selected family tree based on words stored in association with the name for the at least one person. In some implementations, the tokenization process may include creating a pre-token for words stored in association with the name for the at least one person. For example, a pre-token may be formed from the first letter in a word along with one or more consonants of the word. In some implementations, a pre-token can be formed from the first letter in a word and removing one or more vowels from the word. For example, if a starting name is Monika, the pre-token for Monika can be “M^{”} one or more of “N” and “K.” In some implementations, one or more tokens can be created for each word name stored in association with a person in the selected family tree. In some implementations, the one or more tokens are created from the pre-tokens. For example, if a person in the selected family tree has a first name Monika, the process 300 at block 320 may include generating object tokens comprising the first letter of the word and a combination of one or more consonants from the word. Possible object tokens that can be generated for Monika may include “MN,” “MK,” and “MNK,” which forms a token group. If Monika's last name is Black, the process 300 at block 320 may include generating a pre-token of “BLKK” and then generating object tokens such as “BLK,” “BKK,” and “BLKK”. In some implementations, as is discussed below, certain letters can be substituted for other letters (See e.g., Table 1 and Table 2). In the Black example, the “C” can be substituted for “K” as part of a data normalization process for the token generation. It should be appreciated that the token generation process is not limited to words for a person's name. As will be discussed below, tokens can be generated for any other word that is stored in association with a person in a family tree. For example, if a person's occupation is stored as “Builder,” process 300 may include generating tokens, such as “BLD,” “BLR,” “BDR,” and “BLDR” for the word “Builder” in connection with generating facts mapping for the person.

In some implementations, pre-tokens and tokens for words can be created based on one or more rules. In some implementations, one rule for pre-tokens may include generating pre-tokens that include the first letter of a word regardless of whether the first letter of the word is a vowel or a consonant. In some implementations, another rule for pre-tokens may include either removing one or more vowels from the word or adding one or more consonants from the word to the first letter of the word to create a pre-token for the word. In some implementations, the genealogy system may create a pre-token by adding the first letter of a word to the consonants contained in a word to create a pre-token. In some implementations, tokens can be generated based on the pre-tokens. In some implementations, tokens can be generated directly from a word without creating a pre-token for the word. For example, a pre-token for the word “Builder” can be “BLDR.” In some implementations, tokens for the word “Builder” can be created from the pre-token “BLDR.” As another example, tokens for the word “Washington” can be created from a pre-token “WSHNGTN.”

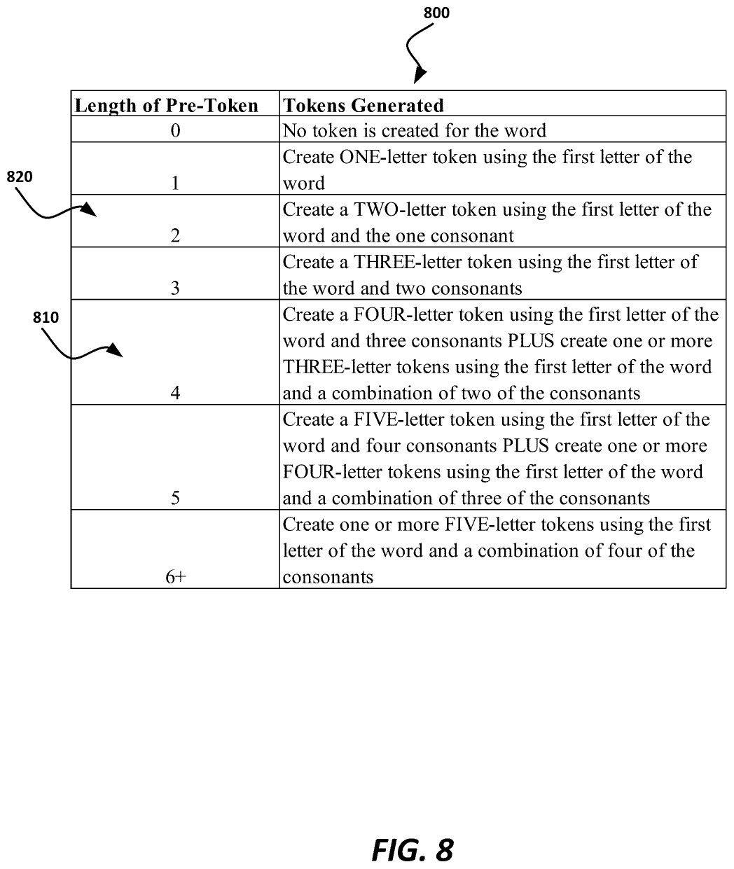

In some implementations, the length of a pre-token can be used to determine a type and quantity of tokens created for a word. Table 800 in FIG. 8 illustrates example rules that can be used to generate tokens based on the length of pre-tokens in some implementations. For example, the genealogy system may create the pre-token “MRTN” from the word “Martin.” The genealogy system may use the example rules in table 800 to determine what tokens to create for the pre-token “MRTN.” The genealogy system may determine that since the pre-token “MRTN” includes four letters, the genealogy system can use the token creation rule in row 810 associated with a pre-token containing four letters. In the case of “MRTN,” the genealogy system may determine that it can create a four-letter token using the first letter of the word and three consonants as well as create one or more three-letter tokens using the first letter of the word and a combination of two of the consonants. For the “MRTN” pre-token example, the genealogy system may generate tokens “MRTN,” “MRT,” “MRN,” and “MTN,” for a token group. Another example using the rules from Table 800 in FIG. 8 include creating the pre-token “HM” from the word “Haim.” As indicated in row 820 of Table 800 in FIG. 8, the pre-token has a length of two letters, and a two letter token can be generated from the pre-token. In the example of “HM,” the genealogy system may generate a token of “HM” from the pre-token “TIM” for a token group.

In some implementations, one or more other rules can be applied to generating tokens in addition to or alternative to the example token creation rules in FIG. 8. For example, one rule may include keeping the letters for tokens in the same order as they appear in the word or pre-token. Using the “MIRTN” example, in some implementations, the “N” is not used before the “R” and “T” to create a token.

In some implementations, a token generation rule may include creating token combinations by substituting certain letters for other letters to normalize word data. The letter substitutions for normalization can help account for issues such as phonetic translations of words, spelling errors, typos, and other situations that may occur when the same words are used in different countries. The following Table 1 and Table 2 are examples of some implementations where letters can be substituted for other letters.

TABLE 1
Letters that can be substituted for each other in a word for pre-
token generation, regardless of placement location in a word

| Letter | Substitute Letter |
|---|---|
| A | U |
| C | K |
| J | Y |
| T | Z |
| TZ | C |
| CH | H |
| [symbol] | [symbol] |
| [symbol] | [symbol] |
| [symbol] | [symbol] |

TABLE 2
Letters that can be substituted for each other everywhere except
for the first letter of a word for pre-token generation.

| Letter | Substitute Letter |
|---|---|
| B | V |
| W | V |

Returning to the example word Black, the pre-token can be generated as “BLCK.” However, because the example rule in Table 1 sets forth that “C” can be substituted with “K”, the resulting pre-token can be generated as “BLKK.” Using the example rules in FIG. 8, the genealogy system may generate a four letter token and one or more three letter tokens based on the four letter pre-token. Thus, in some implementations, the pre-token “BLKK” can result in the tokens “BLKK,” “BLK,” “BLK,” and “BKK” for a token group. In some implementations, tokens do not need to be created for “C” because the same words used with other people in other family trees will be normalized to “K.” In some implementations, because duplicate letters appear in the pre-token, duplicate tokens may be created. In some implementations, the genealogy may skip generating duplicate tokens to save memory and processing power used to generate and store duplicate tokens. In some implementations, the displayed substitutions in Table 1 and Table 2 can be reversed. For example, rather than substituting “C” with “K” in Table 1, the rule can be reversed such that the genealogy system may substitute “K” with “C.” In some implementations, other letter substitutions can be included in the rules. In some implementations, double letter combinations appearing in words can be substituted. For example, Table 1 illustrates that the double letter combination of “TZ” can be substituted with “C.” In some implementations, because Table 1 also has “C” being substituted with “K”, the double letter “TZ” can also ultimately be substituted with “K” for pre-token generation. While many of the letter substitutions examples are shown for the English language, letter or character substitutions can be applied for one or more alphabets used in other languages in some implementations. For example, Table 1 includes a few Hebrew letters and substitutes that can be used for pre-token generation. It should be appreciated that letter and character substitutions can be used with other suitable alphabet types, such as, but not limited to, Cyrillic, Latin, Arabic, Chinese, Devanagari, Hebrew, Greek, Hangul, Japanese Kana, Thai, Sanskrit, etc. It should be appreciated that in some implementations, substituting letters improves the efficiency of the genealogy system. By substituting letters, fewer letters are used which enables the genealogy system to generate and store fewer tokens, which uses less memory and less processing power than if all letters were used. Using the pre-token “BLCK” as an example, if the “C” was not replaced by “K,” the genealogy system may generate the tokens “BLCK,” “BLC,” “BLK,” and “BCK” for the base pre-token and then also “BLKK,” “BLK,” “BLK,” and “BKK” to cover the rule from Table 1 to substitute “C” for “K.” The example rules in Table 2 further aids in this efficiency because the genealogy system can be configured to substitute more than one letter for a single letter. For example, the genealogy system can be configured to substitute instances of “B” and “W” that don't appear as the first letter of the word with “V.”

In some implementations, if an object includes more than one word, the genealogy system may be configured to create separate token groups for separate words, wherein the separate token groups may include one or more tokens. For example, if a last name object is “Luther King,” the genealogy system may create a token group for Luther and a token group for King, wherein the separate token groups have tokens for their respective word. In the last name object Luther King example, the genealogy system may generate a pretoken of “LTHR” for Luther and a pretoken of “KNG” for King. In some implementations, the genealogy system may normalize “LTHR” to “LZHR” based on the substitution rules listed in Table 1 and Table 2 and not further normalize KNG. In some implementations, the genealogy system may also create tokens for “LZHR” and “KNG” based on the token generation rules listed in table 800 in FIG. 8. The genealogy system may create a token group for Luther such as the tokens “LZH,” “LZR,” and “LHR.” The genealogy system may create a token group for King such as the tokens “KNG.”

In some implementations, the genealogy system may include rules to ignore certain predetermined words and not create pretokens, tokens, or token groups for such words. For example, in some implementations, the genealogy system may ignore words such as “the,” “a,” or “of” that may not contribute to helping find matching objects. It should be appreciated that any suitable word or words can be included in rules for the genealogy system to ignore. It should further be appreciated that by ignoring certain words for token generation, the genealogy system is made more efficient reducing the data processing load of the genealogy system processor by reducing the words for the genealogy system to process and also saves computer storage space.

In some implementations, may also ignore a word from a duplicate words set and not create pretokens, tokens, or token groups for both of such duplicate words. Rather, in some implementations, the genealogy system may create one pretoken, one token group, and tokens for one of the words, but not for both of the duplicate words. For example, a user may have added duplicate words for an object, such as a first name or a last name. In some implementations, a nickname may include duplicate words such as “Bong Bong.” It should be appreciated that by ignoring duplicate words for token generation, the genealogy system is made more efficient reducing the data processing load of the genealogy system processor by reducing the words for the genealogy system to process and also saves computer storage space.

In some implementations, the object tokens can be used in the genealogy system to compare against object tokens created for other persons in other family trees to find matches. For example, in the Monika Black example, tokens in the token group created for Monika Black's first name are compared to tokens in token groups created for the first name of other people in other family trees. Likewise, tokens created for Monika Black's last name are compared to tokens created for the last name of other people in other family trees. These tokens enable the genealogy system to perform matching more efficiently than directly comparing full words (e.g., full first names against other full first names; full last names against full last names) because the genealogy system is performing comparison against smaller chunks of data. This word tokenization and comparison system uses less memory and less processing power during the comparison process than if full words were used in the comparison process. The tokenization of words in the improved genealogy system also provides the benefit of finding more relevant matches than in prior, less efficient systems. In some implementations, when vowels are removed from the matching process and the substitute letters are used to create tokens, more potential matches can be captured. For example, the word YAKABOVITZ can match to the word JACKAVOVIZ, whereas in prior genealogy systems, these words might not be considered for potential matches due to their visible differences. The match between YAKABOVITZ and JACKAVOVIZ can result in some implementations because one token for YAKABOVITZ can be YKVVZ and one token for JACKAVOVIZ can also be YKVVZ. This is possible in some implementations because the word YAKABOVITZ can result in a pre-token of YKVVTZ and a token of YKVVZ (e.g., using the rules of Table 800 in FIG. 8 and rules in Table 1). The word JACKAVOVIZ can result in a pre-token of YKKVVIZ and a token of YKVVZ (e.g., using the rules of Table 800 in FIG. 8 and rules in Table 1). The changes in these names could have occurred when a person immigrated from one country to a new country and the name was phonetically changed to match local custom in the new country. Changes to names could also be the result of spelling errors, typos, or for other reasons. By using the innovative tokenization of objects, the genealogy system can account for these changes and efficiently find or correct genealogy records.

In some instances, this token generating and object matching process may result in the capture of matches that are not relevant. However, when combined with additional evaluation systems discussed below, irrelevant or less relevant matches can be reduced or eliminated despite capturing more object matches with the tokenization process.

Returning to FIG. 3, process 300 at block 330 may include generating facts mappings objects for at least one person in the selected family tree. In some implementations, facts associated with a person are life events associated with a person (e.g., what a person does, where they lived, awards they have received, etc.). In some implementations, facts mapping may include normalizing profile information data stored in association with a person in the selected family tree and generating tokens for the normalized data. For example, if a person is associated with an identified occupation of “Builder,” the genealogy system may generate a pre-token for the word using the one or more rules discussed above in connection with generating name tokens. In some implementations for example, the genealogy system may generate a pre-token for “Builder” as “BLDR” by keeping the first letter of the word and the consonants. Applying the same rules as noted above in connection with block 320, the genealogy system may generate resulting tokens such as “BLDR,” “BLD,” “BLR,” and “BDR.” Fact mapping may include normalizing one or more letters, such as replacing letters noted in Table 1 and Table 2 for fact mapping objects. In the case of the pre-token “BLDR,” however, the pre-token letters of “BLDR” did not require further normalization. It should be appreciated that the replacement letter mapping may be different than that shown in Table 1 and Table 2 and in some alternative implementations, pre-token “BLDR” could be normalized. In some implementations, the genealogy system may perform fact mapping, normalization, and tokenization of other facts stored in association with a person in the selected family tree. Other fact objects may include, but are not limited to, places of residences for the selected person, books the selected person authored, other names of the person (e.g., nicknames, maiden names, prior legal names, etc.). This tokenized fact mapping objects can be stored as part of the index for a person in the selected family tree and can be stored alongside other objects that can be used for later comparison and matching purposes (e.g., name objects tokens, relations object tokens, other assets associated with the selected person like gender). It should be appreciated that tokenized facts mappings objects can be generated for some or all of the people in the selected family tree.

Process 300 at block 340 may include generating relations mappings objects for at least one person in the selected family tree, normalizing the data, and tokenizing the data. In some implementations, the genealogy system stores direct familial relationships for a family tree, but does not store indirect familial relationships. By not storing indirect familial relationships in the family tree, this can save storage space related to data needed to be stored for a family tree. For example, a person in a family tree may have direct relationships stored such as the person's parents, siblings, spouse, kids, and in-laws, but may not have relationships stored for links to grandparents, grandkids, and further distant relatives. However, the genealogy system may create more distant relationship information for people in a family tree and store these relationship objects (as normalized and tokenized data) in the index for the selected person. In some implementations, the normalized and tokenized data is created similar to the normalized and tokenized data discussed in connection with block 320. This relationship information in the index for a person can help determine potential matches with the person as will be further explained below.

Process 300 at block 350 may include storing the index and tokenized objects created for persons for the selected family tree. An example index with tokenized objects for the matching comparison analysis may include, but is not limited to, the example in Table 3:

TABLE 3
Index example

```
partners: [
    {
      id: ‘f00b93d6-6221-4269-8672-38a9e7e28d02’,
      firstName: {
        length: 6,
        tokens: [
          ‘MN’,
          ‘MK’,
          ‘MNK’
        ]
      },
      lastName: {
        length: 5,
        tokens: [
          ‘BLK’,
          ‘BKK’,
          ‘BLKK’
        ]
      },
      gender: ‘f’
    }
  ],
  parents: [
    {
      id: ‘2a81b91a-6e0a-47fa-9433-6f031cf7b835’,
      firstName: {
        length: 5,
        tokens: [
          ‘FRN’,
          ‘FRK’,
          ‘FNK’,
          ‘FRNK’
        ]
      },
      lastName: {
        length: 5,
        tokens: [
          ‘SMZ’,
          ‘SMH’,
          ‘SZH’,
          ‘SMZH’
        ]
      },
      gender: ‘m’
    },
    {
      id: ‘548857c4-652f-4508-ad05-e082b04a74e7’,
      firstName: {
        length: 4,
        tokens: [
          ‘KZ’
        ]
      },
      lastName: {
        length: 5,
        tokens: [
          ‘SMZ’,
          ‘SMH’,
          ‘SZH’,
          ‘SMZH’
        ]
      },
      gender: ‘f’
    }
  ],
  children: [
    {
      id: ‘74e81578-f75b-4de7-996a-7b05b30caa23’,
      firstName: {
        length: 6,
        tokens: [
          ‘PRK’,
          ‘PRR’,
          ‘PKR’,
          ‘PRKR’
        ]
      },
      lastName: {
        length: 5,
        tokens: [
          ‘BLK’,
          ‘BKK’,
          ‘BLKK’
        ]
      },
      gender: ‘m’
    },
    {
      id: ‘2f5f8fd1-70bb-4e8f-8ca7-8b9cbfe05b9d’,
      firstName: {
        length: 5,
        tokens: [
          ‘SR’,
          ‘SH’,
          ‘SRH’
        ]
      },
      lastName: {
        length: 5,
        tokens: [
          ‘SMZ’,
          ‘SMH’,
          ‘SZH’,
          ‘SMZH’
        ]
      },
      gender: ‘f’
    }
  ],
  siblings: [
    {
      id: ‘335f3a9b-d963-4e15-810e-cd1d9fccd260’,
      firstName: {
        length: 7,
        tokens: [
          ‘DRRL’,
          ‘DRLL’,
          ‘DRRLL’
        ]
      },
      lastName: {
        length: 5,
        tokens: [
          ‘SMZ’,
          ‘SMH’,
          ‘SZH’,
          ‘SMZH’
        ]
      },
      gender: ‘m’
    },
    {
      id: ‘0cf0aac0-9ecd-486c-8df7-9a9e77398aed’,
      firstName: {
        length: 5,
        tokens: [
          ‘KN’,
          ‘KD’,
          ‘KND’
        ]
      },
      lastName: {
        length: 5,
        tokens: [
          ‘SMZ’,
          ‘SMH’,
          ‘SZH’,
          ‘SMZH'
        ]
      },
      gender: ‘f’
    }
  ],
  parentsInLaw: [ ],
```

As should be clear from the above example index in Table 3, the index for the selected person includes objects like the person's partner, parents, children, siblings, parents-in-law. Some of objects include the descriptor of “length.” Length relates to the length of the original word. It should be appreciated that in some implementations, fewer or more similar objects can be stored in the index for the person.

In some implementations, process 300 may have created an index for one or more persons in a family tree. These indexes may be stored in association with the selected family tree and used for comparing against other indexes of people from other family trees in the matching process that will be further discussed herein.

Although FIG. 3 shows example blocks of process 300, in some implementations, process 300 may include additional blocks, fewer blocks, different blocks, or differently arranged blocks than those depicted in FIG. 3. Additionally or alternatively, two or more of the blocks of process 300 may be performed in parallel.

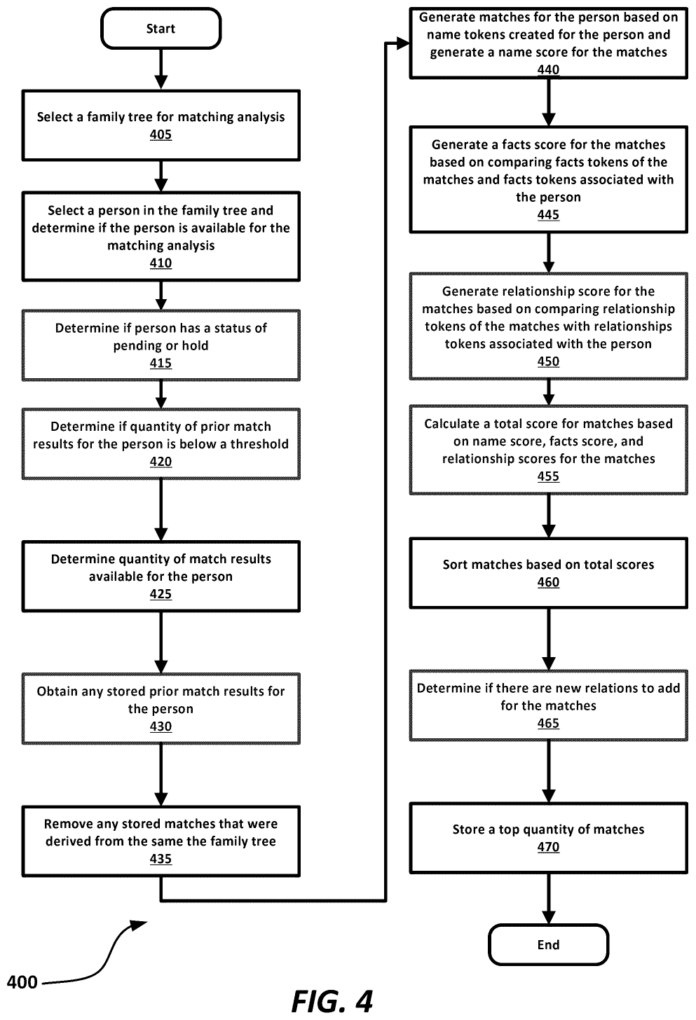

FIG. 4 is a flowchart of an example process 400 of searching and matching objects from indexes in a genealogy system. In some implementations, process 400 can be performed by a processor, such as processor 705 specially programmed to execute one or more functions of process 400 in a computing system 700. In some implementations, one or more process blocks of FIG. 4 may be performed by one or more processors of a genealogy system.

As shown in FIG. 4, process 400 at block 405 may include selecting a family tree from a plurality of stored family trees for matching analysis. Process 400 at block 410 may include selecting a person in the selected family tree and determining if the selected person is available for a matching analysis. In some implementations, a selected person from the selected family tree may not have enough information to compare against other persons in other family trees. In some implementations, process 400 at block 410 may examine one or more objects in the selected person's index to determine if the selected person is eligible for a matching analysis and calculate a matching analysis initiation score. If the matching analysis initiation score is above a predetermined threshold, the process 400 can continue for the selected person. In some implementations, the predetermined threshold matching analysis initiation score can be three points. It should be appreciated that the predetermined threshold matching analysis initiation score can be any suitable number. In some implementations, the process 400 at block 410 may determine whether at least the selected person's first name or last name is not null (e.g., a name entry is in either the first or last name fields). In some implementations, processor 705 may calculate a score of +1 (or one point) for the selected user having a recorded first name or last name. This can be determined from the tokens objects created for the selected person's name or from the full name entries objects in the family tree. In some implementations, the process 400 at block 410 may determine the quantity of relatives the selected person has in the family tree. The process 400 may look at the index objects created for the selected person or look at entries in the family tree. In some implementations, process 400 at block 410 may add an additional point for each relative object stored for the selected person. In some implementations, the process 400 at block 410 may also determine the quantity of profile information (e.g., fact information) stored in the family tree for the selected person. The profile/fact information may include, but is not limited to, profession, residence, nicknames, alternative names, author of, date of birth, date of death, birth city, hobbies, etc. In some implementations, process 400 at block 410 may add an additional point for each profile/fact information stored for the selected person. As with the name and relative object information, the process 400 at block 410 can look at the index associated with the selected person or in the information stored in the family tree to make the determination. In some implementations, if the matching analysis initiation score for the selected person is 3 or more points, then the processor 705 may determine that enough information objects exists for the selected person to proceed with the matching analysis. It should be appreciated that the threshold quantity of points can be set at any suitable number.

In some implementations, process 400 may end for the selected person if the genealogy system determines that the selected person is not eligible for the matching process. While process 400 may terminate or end early in accordance with some blocks discussed herein, it should be appreciated that this does not prevent process 400 from being rerun for such person in the future (e.g., the next time the process 400 is run for one or more family trees). For example, in some implementations, processor 705 can run process 400 once a day, multiple times a day, continuously, etc. If process 400 is terminated early for a person during one run, the process 400 can be rerun for the person during the next run of process 400 or at some subsequent run of process 400.

Process 400 at block 415 may include determining if the selected person has an associated status of pending or hold. In some implementations, the selected person may have a status that prevents the genealogy system from providing updates or corrections to the selected person. For example, the genealogy system may already be in the process of providing updates or corrections to the selected person and such updates may be processed at a later time. In some implementations, avoiding further updates or corrections may be used to avoid corrupting data for a selected person. In some implementations, a user may be reviewing the person for updates or corrections. In some implementations, if the selected person's status is pending, hold, or some other suitable indicator that makes the selected person unavailable for matches, the genealogy system at process 400 may end the matching process for the selected person. If the selected person is not associated with an indication that the process 400 should be skipped for such selected person at block 415, process 400 may move to block 420 to continue the matching process.

Process 400 at block 420 may include determining whether the quantity of prior potential match results for the selected person is below a predetermined threshold. In some implementations, the system may restrict how many potential match results can be stored for the selected person. In some implementations, because match results are presented to a user, the genealogy system may limit the quantity of match results that can be presented to a user to reduce potential confusion for the user. Also, limiting the quantity of match results that can be stored for the selected user saves system memory and storage as well as makes the genealogy system process more efficient by reducing the quantity of persons that are processed for matching at a given time. In some implementations, the predetermined threshold quantity of prior match results can be three or some other suitable number. In some implementations, each person has the same predetermined threshold quantity of prior match results. In some implementations, different persons may have different predetermined threshold quantity of prior match results.

Process 400 at block 425 may include determining the quantity of matches that remain available to create for the selected person. In some implementations, the quantity of prior matches that are available to create for the selected person is the threshold quantity of prior matches minus the prior quantity of match results that are stored for the selected person. For example, the predetermined threshold quantity of prior match results is three and the stored prior match results is three, then the selected person does not have available additional match results to create. In some implementations, the process 400 may terminate for the selected person. As another example, if the predetermined threshold quantity of prior match results is three and the stored prior match results is one, then the selected person can have up to two additional potential match results created and stored.

Process 400 at block 430 may include obtaining any stored prior determined match results for the selected person. Process 400 at block 435 may include removing any stored prior determined match results for the selected person that were determined from the family tree. In some implementations, the process 400 at block 435 can prevent the genealogy system from offering the user of a family tree potential matches of persons that the user already added to the family tree.

Process 400 at block 440 may include generating potential matches to other persons from other family trees for the selected person based on comparing name objects from the selected person's index and generating a name score for the potential matches. In some implementations, the tokens created for the name objects in the index (e.g., the first name and last name tokens created in process 300 of FIG. 3) are obtained for the selected person and compared against one or more other name object tokens created for other people in other family trees stored by the genealogy system. The other people in other family trees and their respective objects may be referred to as found people and found objects. In some implementations, the matching process at block 440 examines multiple aspects of name objects to determine potential matches. In some implementations, processor 705 may apply one or more rules based on the length of word objects, quantity of consonants, or both in a word object to determine whether the objects are suitable for the matching process.

For example, in some implementations, one rule may include if a word is less than or equal to 6 letters, it can be matched to a word that has + or −2 letters (e.g., a word that has between 4 and 8 letters). Words that have greater than 8 letters would not match with this rule and words that have less than 4 letters would not match with this rule. It should be appreciated that the + or − letter range can be increased or decreased in some implementations. In some implementations, the rule for words that are less than or equal to 6 letters can be further extended to include matching token objects based on the first letter of the word and at least 2 other matching consonant letters appearing in the tokens for the word. For example, the last name Black includes 5 letters, so the foregoing rule could apply. The processor 705 may examine last names associated with persons from other family trees to look for words that have between 3 and 7 letters. Processor 705 could skip words that had more than 7 letters for last names or fewer than 3 letters for last names. If the processor 705 found last names between 3 and 7 letters, process 705 could compare tokens of the last name Black for matches such as “BLKK,” “BLK,” and “BKK.” As another example, the processor 705 may search for the first name Asher. Asher has 5 letters, so processor 705 could skip words that had more than 7 letters and fewer than 3 letters for a first name. Using the rules provided in connection with FIG. 3, an initial pre-token for Asher is ASHR, but due to normalization from Table 1, the pre-token for Asher is USHR. The processor 705 may have generated tokens such as USHR, USH, USR, UHR. Accordingly, a found user with the first name Usher is a candidate for a match analysis. In this case, doing a token comparison, ASHER can match to USHER because the words are for first names, the same quantity of letters is in both names, and the tokens for both of these words can be USHR, USH, USR, and UHR (e.g., creating multiple token matches). In some implementations, a match would accumulate one point for the found person with the first name Usher.

In some implementations, another rule could be applied for words that have a quantity of letters that range between 7 and 9 letters. Words having letters less than 7 or greater than 9 would not conform to this rule. The processor 705 may examine words in name objects from other family trees to look for words that have + or −2 letters from the range between 7 and 9 letters and skip words that are not within this range. For example, if a word to match in a name object includes 7 letters, processor 705 may look for name objects from other family trees that have been 5 and 9 letters. As another example, if a word to match in a name object includes 8 letters, processor 705 may look for name objects from other family trees that have been 6 and 10 letters. In some implementations, this rule for words can be further extended to include matching token objects based on the first letter of a token for the word and at least 3 other consonant letters in the token. For example, the last name Halpern includes 7 letters, so the foregoing rule could apply to this name. Using the rules and tables discussed in FIG. 3, the processor 705 may generate a pre-token “HLPRN” for the name object Halpern. The pre-token does not undergo further normalization based on not having matching letters in replacement based on Table 1 or Table 2. In some implementations, the processor 705 may generate tokens of “HLPRN,” “HLPR,” “HLPN,” and “HPRN.” The processor 705 may examine last names from other family trees to look for words that have between 5 and 9 letters. Processor 705 could skip words that had less than 5 letters or more than 9 letters for last names. If the processor 705 found last names with between 5 and 9 letters, process 705 could compare tokens such as “HLPRN,” “HLPR,” “HLPN,” and “HPRN” for matches with other last name token from other family trees. As another example, the processor 705 may search for the first name Merylash. Merylash has 8 letters so processor 705 may look for name objects from other family trees that have been 6 and 10 letters. Using the rules and tables discussed in FIG. 3, the processor 705 may generate a pre-token “MRYLSH” for the name object Merylash. The pre-token does not undergo further normalization based on not having matching letters B, V, W, A, C, J, T, TZ, CH based on Table 1 or Table 2. It should be appreciated that if Table 1 could be configured to set J as a replacement for Y, processor 705 may be configured to replace the Y in the pre-token with J. In some implementations, the processor 705 may generate tokens of “MRYLS,” “MRYLH,” “MRYSH,” “MRLSH,” “MYLSH.” Merylash has 8 letters, so a found user from another family tree with the first name Meriellosh (which has 10 letters) is a candidate for a match analysis because Meriellosh is between 6 and 10 letters long. Using the rules and tables discussed in FIG. 3, a pre-tokens for Meriellosh is MRLLSH. In this case, doing a token comparison using the generated tokens for Merylash, Merylash can match to Meriellosh because the words are for first names, the quantity of letters for Meriellosh is within the defined range of 6-10 letters, the tokens for these words can result in a match. For example, Merylash can match to Meriellosh because tokens for these words may both include MRLSH.

In some implementations, another rule could be applied for words that have a quantity of letters that are greater than or equal to 10 letters. In some implementations, words suitable for potential matching may include words that have letters that are within a range of ±2 letters of the word to be matched. For example, for a word of length 10, words having letters less than 8 letters and more than 12 letters would not conform to this rule. As another example, for a word of length 14, words having letters less than 12 letters and more than 16 letters would conform to this rule. The processor 705 may examine words in names objects from other family trees to look for words that meet the defined range of letters and skip words that are not within this range. Using the example last name Yakabovitz, the processor 705 may determine that the foregoing rules could apply because Yakabovitz includes 10 letters. The processor 705 may examine last names from other family trees to look for words that have between 8 and 12 letters in the last name objects. In some implementations, processor 705 could skip words that had less than 8 letters or more than 12 letters for last names. If the processor 705 found last names with between 8 and 12 letters, processor 705 could compare tokens of the last name Yakabovitz against token for names from other family trees that are with the defined range of between 8 and 12 letters. Using the rules and tables discussed in FIG. 3, processor 705 may generate a pre-token of YKBVTZ for Yakabovitz. Processor 705 may further normalize the pre-token because one or more letters match letters to be converted from Table 1 and Table 2. In this example, Table 2 indicates that B is substituted with V, thus the pre-token can be converted to YKVVTZ. The tokens for YKVVTZ may include “YKVVT,” “YKVVZ,” “YKVTZ,” “YKVVZ” (based on having 6 letters in the pre-token using the rules from Table 800 in FIG. 8). for matches such as “YKBVT,” “YKBVZ,” and “YKVVT,” “YKVVZ,” etc. Using the length of the name object for Yakabovitz of 10 letters, the process 705 may determine that the name object Jackavoviz can be a potential match because it contains the quantity of letters with the range of 8-12 letters. Further both Yakabovitz and Jackavoviz have matching tokens of “YKVVZ” (e.g., the pre-token for Jackavoviz is JCKVVZ, which is normalized to YKKVVZ and can result in the tokens “YKKVV,” “YKKVZ,” and “YKVVZ”).

In some implementations, short words may have fewer than normal consonant letters besides the first letter. Examples include words like “HAIM” or “SAM.” In some implementations, processor 705 may use a matching rule such as matching the first letter and one consonant letter for words that do not fit into other rules. For example, if the processor 705 had a primary object of a first name Haim to match against other first names from other persons in other family trees, the processor 705 could compare tokens of first names from first name objects associated with other people in other family trees of that include “HM” tokens. An example of this matching may include HAIM and HAMI because the tokens for these two words are HM.

In some implementations, certain languages may have additional rules to apply to the matching analysis. For example, for Hebrew, in some implementations, all letters can be considered consonant letters, even if some letters are used as vowels.

It should be appreciated that by using an initial screening of word objects based on quantities of letters helps cut down on the quantity of word objects that processor 705 compares for additional matching, which saves memory usage and processing power during the matching process to create a faster and more efficient search in a genealogy system.

In some implementations, if a match is found, processor 705 accumulates one point for each found name in another family tree that is determined to match to create a name score for such found names. In some implementations, if a first name in a found person (e.g., a person from a family tree that is different from the selected person that is the basis for a search) matches with the selected person's first name, processor 705 would accumulate one point (or some other suitable quantity of points) for this match. If a last name in a found person (e.g., a person from a family tree that is different from the selected person that is the basis for a search) matches with the selected person's last name, processor 705 would accumulate one point for this match. If both a first name and last name match on a found person, this found person would have an accumulated name score of 2 points. The name score can be added to other scoring analysis to determine a total score for a found person relative to the selected person. It should be appreciated that the points assigned to a name match can be set at different point amounts in some implementations.

In some implementations, where a name object includes more than one word (e.g., a last name of Luther King), the genealogy system may award separate points for matches for separate words in a name object. For example, if a token for Luther matched a token for a found person, the genealogy system may assign one point for the match for the name score. If a token for King also matched a token for a found person, the genealogy system may assign another point for the match for the name score. Thus, matching tokens for Luther and King could results in a name score of 2 points for a last name. In some implementations, where a name object includes more than one word, the genealogy system can be configured to provide partial points (e.g., 0.25 points or some other suitable quantity of points) having a partial match matching (e.g., matching one word, but not all words in the name object). Using the Luther King last name object example, if King resulted in a name match, but Luther did not result in a name match, the genealogy system may award one point for King and 0.25 points for the non-matching Luther.

In some implementations, the process 400 at block 440 may also obtain data from sources outside of the genealogy system to compare against data stored in association with the selected person. In some implementations, the data obtained from other sources outside of the genealogy system can be tokenized to compare against the tokens for the selected person.

Process 400 at block 445 may include generating a fact score for the potential matches based on comparing facts of the potential matches to facts associated with the selected person. For example, where names have been matched in block 440, processor 705 may then additionally compare facts/profiles from such matches. In some implementations, the fact matching follows a process similar to the name matching process discussed in connection with block 440. That is, facts/profile objects can be initially compared on the basis of letter quantities for word objects per the aforementioned rules, and then tokens for the fact/profile objects can be compared if the letter quantity analysis determined to be acceptable. If matches are determined based on token comparison analysis, then processor 705 can accumulate 0.25 points (or some other suitable quantity of points) for each fact/profile for found persons from other family trees that are determined to match to create a facts score for such found persons. It should be appreciated that facts/profiles can be compared using alternative suitable methods. It should also be appreciated that in some implementations, fact matching and fact scores for potential matches can be generated for other people from other family trees independent of matches made based on name matching from block 440. For example, fact matching and fact scores can be generated prior to performing any name matching analysis. In some implementations, process 400 can be configured to find fact matches between the selected person and other persons from other family trees without one or more matching names. This could occur for example where names for the selected person are unknown or are otherwise incorrect, but one or more facts about the selected person is known.

Process 400 at block 450 may include generating a relationship score for the potential matches based on comparing relationships of the potential matches to relationships associated with the selected person. For example, where names have been matched at block 440, processor 705 may then compare relationships from such matches. In some implementations, the relationship matching can follow a process similar to the name matching process discussed in connection with block 440. That is, for example, names from relationships objects are compared on a letter quantity basis for word objects, and then tokens for the name objects can be compared if the letter quantity analysis is determined to be acceptable. In some implementations, for relationship objects to be considered a match for relationship scoring purposes, a combination of multiple relationship objects can be used to determine a match. In some implementations, a threshold quantity of matching relationship objects is four to determine a match for relationship scoring purposes. For example, for a selected person to have a match for relationship scoring purposes with a found person based on relationships, a combination of multiple objects from a relative of the selected person can be used to determine a match such as a combination of a first name, a last name, a gender, and a relationship type with a relative of a found person from another family tree.

TABLE 4

| | |
|---|---|
| Selected Person: Frank Unknown | Found Person: Frank Sweeny |
| Relative First Name: Lawrence | Relative First Name: Lawrence |
| Relative Last Name: Sweeny | Relative Last Name: Sweeny |
| Relative Gender: M | Relative Gender: M |
| Relative Relationship: Father | Relative Relationship: Father |

The selected person in TABLE 4 (e.g., Frank with an unknown last name) has a father listed as Lawrence Sweeny. TABLE 4 also shows a found person (Frank Sweeny) from another family tree with a father listed as Lawrence Sweeny. The relative information may be obtained from indexes stored in association with the selected person and the found person. In this example, four objects for a relative of Frank with an unknown last name match, which processor 705 can determine as a relationship match and accumulate a 0.5 point (or some other suitable quantity of points) for the found person Frank Sweeny. In some implementations, a combination or fewer or more matching objects can be used to determine a relationship match. In some implementations, different relationship objects than shown in TABLE 4 can be used to determine a relationship match.

In some implementations, if object matches are determined for a relationship match, then processor 705 can accumulate 0.5 points (or some other suitable quantity of points) for a matching relationship for found people in the other family trees. It should be appreciated that relationships can be compared and matched using alternative suitable methods. It should also be appreciated that in some implementations, relationship matching and relationship scores for potential matches can be generated for other people from other family trees independent of matches made based on name matching from block 440 or fact matching from block 445. For example, relationship matching and relationship scores can be generated prior to performing any name matching analysis or performing any fact matching analysis. In some implementations, process 400 can be configured to find relationship matches between a selected person and other persons without any matching names.

Process 400 at block 455 may include calculating a total score of the potential matches based on the name score, fact scores, and relationship scores for the potential matches (e.g., found people with matches determined in block 440, block 445, and/or block 450). For example, for a found person that had match scores generated from names, facts/profile information, and/or relationships, processor 705 can add the scores generated in block 440, block 445, and/or block 450 to determine a total score for the found person. In some implementations, processor 705 performs this tally for one or more found persons from other family trees. In some implementations, if a total score for a found person is less than a threshold value, such as less than 1.75 points, then such a found person may be discarded as a potential match. It should be appreciated, that the threshold total score can be any suitable score value. In some implementations, processor 705 does not discard any found person with a score greater than zero. Process 400 at block 460 may include sorting potential matches based on the total scores. It should be appreciated that potential matches can be sorted in any suitable manner. Other scoring methods can be used in conjunction with the total score to determine the best matches.

In some implementations, in addition to or alternative to measuring the points for a total score, the genealogy system may determine whether a found person is a match based on whether a found person has a predetermined combination of matching objects (e.g., at least three matching objects or some other suitable quantity of matching object) to a selected person. For example, the genealogy system may determine a match with a found person if a found person had matches with the selected person based on one name object (e.g., either the first name or last name) and any two other objects (e.g., relation objects or facts objects). For example, the genealogy system may determine a match between a found person and the selected person where first name matches, at least one fact matches, and at least one other fact matches. Other match combinations may include the second names match, one relation matches, and at least one fact matches; first names match and at least two relations match (e.g., partner, parent, child); second names match and at least two facts match; or second names match and at least two types of relations match. It should be appreciated that other suitable combinations can be used to determine matches. In some implementations, determining whether the selected person has three objects match with a found person is a threshold determination, wherein if at least three object match, then the genealogy system may use the scoring discussed above to determine the best possible matches. In some implementations, where an object include more than one word (e.g., using the Luther King last name example), if one of the words in the last name object is a match, the genealogy system may determine that last name is considered a matching object that counts toward the at least three object matches. In some implementations, where an object include more than one word (e.g., using the Luther King last name example), if multiple words in the last name object are matching, the genealogy system may determine that last name is considered one matching object that counts toward the at least three object matches (e.g., in some implementations, multiple matching words in one last name object does not increase the quantity of matching objects).

In some implementations, the genealogy system may perform a full word match (e.g., matching a person's full first name to the full first name of another person or with one or more other objects) as a further test determine the most appropriate matches. In some implementations, matching full names against other names can be performed after the token matching is performed. In some implementations, matching against full words is performed where a match is determined as discussed in connection with block 455 above. In some implementations, if a match is determined based on a full word comparison, a found person's total score can be increased by a predetermined amount, such as 0.5 points (or any suitable quantity of points). In some implementations, the genealogy system may resort the matches based on the update total scores. Matching full words is processor and memory intensive, thus configuring the genealogy system to limit matching full words creates a more efficient genealogy system. In some implementations, matching full names against other names can be performed before the token matching is performed or after the token matching is performed. In some implementations, the matching process may include using vowels of the base word used to create the tokens used for matching purposes.

Process 400 at block 465 may include determining whether there are new relations to add to the selected family tree based on the matches. For example, if a match is made between a selected person and a found person from another family tree, the processor 705 may determine if there are any new relations to add to the family tree for the selected person. In some implementations, if there are no new relationships to the selected family tree for a potential match and/or there are no other updates to the selected family tree from the potential match, processor 705 may discard the match.

Process 400 at block 470 may include storing a predetermined quantity of matches for the selected person in the selected family tree. In some implementations, processor 705 may store up to a predetermined quantity of matches for the selected person. In some implementations, the matches that are stored are reviewed to determine if they have a total score greater than a threshold score (e.g., 3 points or higher or some other suitable number). In some implementations, processor 705 determines how many remaining matches can be stored associated with the selected person based on the outcome at block 425 and stores this quantity of matches with the highest total scores. In some implementations, the resulting matches can be sorted in any suitable manner.

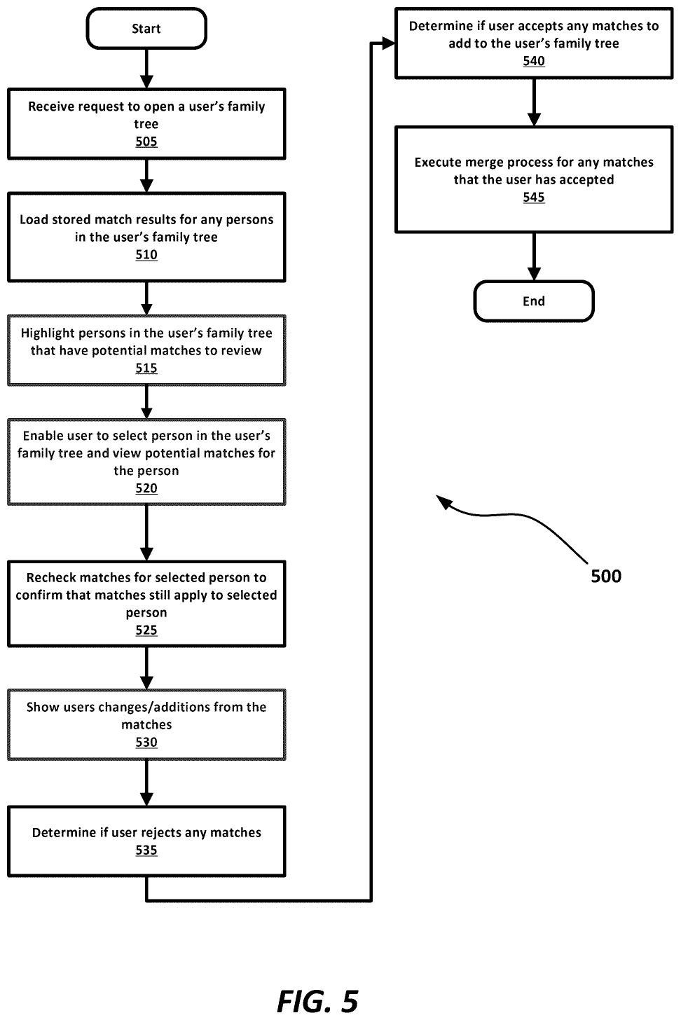

The matching process can be performed for one or more persons in the selected family tree. In some implementations, the matching process can be performed for each person in the selected family tree. In some implementations, the matching process can be performed for one or more family trees stored in the genealogy system. In some implementations, the matching process can be performed for each family tree stored in the genealogy system. The matching process can be performed at any suitable time. In some implementations, the matching process is performed during time periods when the system usage is low to avoid impacting system users. In some implementations, the matching process can be performed in batch processes, such that the genealogy system can analyze one or more persons in one or more family trees against persons in other family trees as well as from other data sources for potential matches to correct or otherwise update a family tree. In some implementations, the genealogy system can analyze each person in each family tree. In some implementations, the matching analysis can be performed once a day or at some other desired frequency. Potential matches determined during the process 400 can be presented to users who have a family tree to update their family tree, as is discussed below in connection with FIG. 5.

In some implementations, a user can switch off/on the process 400 for the user's family tree(s). It should be appreciated that switching off process 400 may stop the searching process for the user's family tree(s), thus saving memory and processing power for genealogy system.

Although FIG. 4 shows example blocks of process 400, in some implementations, process 400 may include additional blocks, fewer blocks, different blocks, or differently arranged blocks than those depicted in FIG. 4. Additionally or alternatively, two or more of the blocks of process 400 may be performed in parallel.

FIG. 5 is a flowchart of an example process 500 of a genealogy system providing selections for updating a family tree to users of the genealogy system. In some implementations, process 500 can be performed by a processor, such as a processor 705 specially programmed to execute one or more functions of process 500 in a computing system 700. In some implementations, one or more process blocks of FIG. 5 may be performed by a genealogy system.

As shown in FIG. 5, process 500 at block 505 may include receiving a request to open a user's family tree for display. Process 500 at block 510 may include loading stored match results for any persons in the user's family tree. For example, matches created from process 400 can be loaded for display to a user.

Process 500 at block 515 may include transmitting the requested family tree to the user, where the transmission provides an indication of at least one person in the requested family tree with at least one potential match to review. In some implementations, this may include providing the selected family tree for display to a user in a manner to highlight persons in the family tree that have potential matches to review.

Process 500 at block 520 may include enabling the user to select the at least one person in the requested family tree with the at least one potential match for review. Process 500 may also include receiving from the user a (e.g., from user terminal 120a) selection of the at least one person from the family tree to review the at least one potential match.

Process 500 at block 525 may include rechecking the selected at least one person and the at least one potential match to confirm that matching information is still valid. In some implementations, processor 705 may perform the recheck to determine if any information about the selected at least one person has changed since the last matching process (e.g., process 400) was run for the selected at least one person. For example, a user may have changed the selected person's name, facts/profile information, relationships since the match process was last executed. A potential match from another family tree also could have been updated since the match process (e.g., process 400) was last run. Changes to the selected person or a found person may have altered the total score for the matches and make a match unsuitable for updating the selected family tree. It should be appreciated that in some implementations, block 525 is not performed and any match previously made can be transmitted to a user.

Process 500 at block 530 may include transmitting at least one of changes and additions from the at least one potential match that can be applied to the selected at least one person. In some implementations, possible changes from the selected person and a found person can be presented to a user (e.g., transmitted to a user terminal for display to a user). In some implementations, possible changes to a selected person or the selected family tree can be displayed in red to a user. It should be appreciated that any suitable color can be used to highlight the possible changes. In some implementations, possible changes can be highlighted to a user in any suitable manner.

In some implementations, process 500 at block 530 may include providing additional relatives of the potential match to add or update in the selected family tree. In some implementations, processor 705 system will limit records of additional relatives of the potential match to close relatives (e.g., relations that have substantially direct connections to the potential match). These direct connections may include parents, children, spouses, siblings, parents-in-law. In some implementations, direct connections may exclude relations such as grandparents, grandkids, cousins, and other relations that have less direct connection to potential match. For example, if a grandfather has a new father to add, process 500 may include showing the father of the grandfather to add, but the system would not show the grandchild of the grandfather to add. In some implementations, reducing the quantity of potential relations to show as updates to the selected family tree helps minimize duplicative updates to records and minimize confusing a user with too many update choices for the selected family tree. In some implementations, reducing updates to direct connections also decreases the amount of data to store, process, and send to the user, thus making the genealogy system more efficient by limiting the choices stored and shown. It should be appreciated that in some implementations, the definition of direct connections can be reduced or expanded to add more possible people to update or reduce the amount of people to update.

Process 500 at block 535 may include determining that the user rejected the at least one potential match to update the selected family tree. For example, a user at a user terminal may reject a presented match and send a rejection indication to processor 705. In some implementations, processor 705 may mark the reject match in a manner such that the present match is not provided to the user in the future. In some implementations, the match can be labeled such that in the next and subsequent runs of process 400, the reject match is ignored. In some implementations, avoiding the rejected match can be for a limited time, such as 1 month or 6 months, or 2 years. In some implementations, the rejected match can be configured to become a match again and be presented to the user in the future.

Process 500 at block 540 may include determining that the user accepted the at least one potential match to update the selected family tree. In some implementations, processor 705 may receive from a user terminal a message to accept the at least one potential match. In some implementations, processor 705 may process the selection to merge changes into the selected family tree.

Process 500 at block 545 may include executing a merge process to update the selected family tree with the information associated with the at least one potential match.

Although FIG. 5 shows example blocks of process 500, in some implementations, process 500 may include additional blocks, fewer blocks, different blocks, or differently arranged blocks than those depicted in FIG. 5. Additionally or alternatively, two or more of the blocks of process 500 may be performed in parallel.

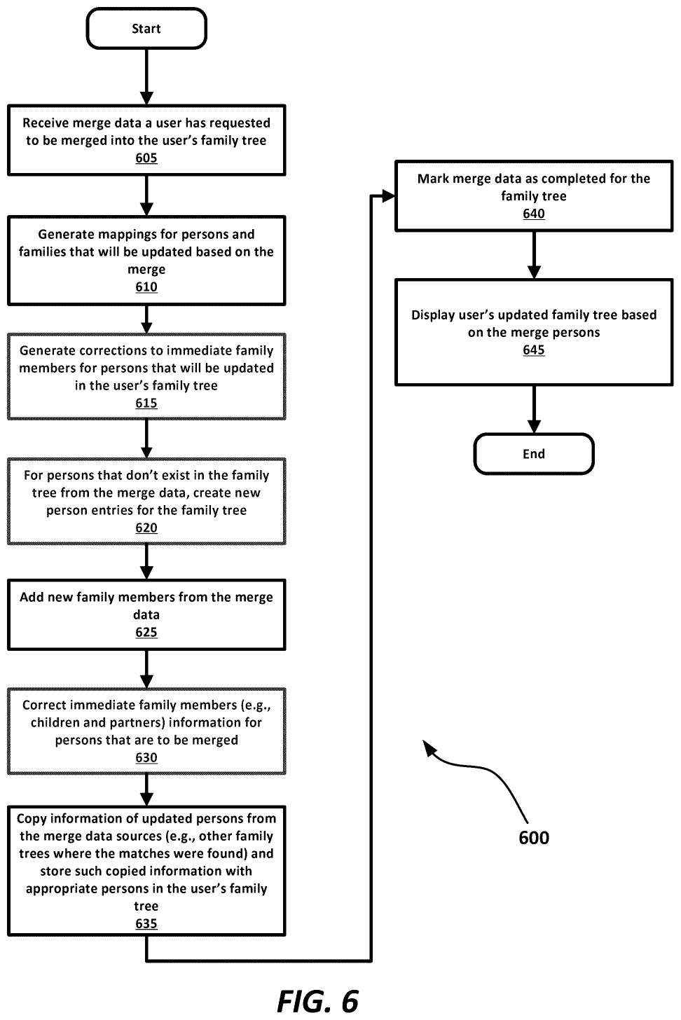

FIG. 6 is a flowchart of an example process 600 of a genealogy system merging matches into a family tree. In some implementations, process 600 can be performed by a processor, such as a processor 705 specially programmed to execute one or more functions of process 600 in a computing system 700. In some implementations, one or more process blocks of FIG. 6 may be performed by a genealogy system.

As shown in FIG. 6, process 600 at block 605 may include receiving a request to merge data from a first family tree to a second family tree. For example, the processor 705 may receive a user's selection of found person and one or more data objects from the found person can be merge into the second family tree (e.g., block 540 in process 500 from FIG. 5). In some implementations, the user's selection may include the found person and one or more persons with direct connections to the found person. In some such implementations, adding or updating the one or more persons with direct connections to the found person to the second family tree will include adding or updating objects associated with these one or more persons.

In some implementations, if user chooses a match or found person for merging into the second family tree (e.g., the user's family tree), other persons, such as directly connected persons may also be required to be added or updated in the second family tree. For example, if a found person and additional persons with direct connections to the found person are selected and one of the additional persons does not have a direct connection in the second family tree, the genealogy system may not permit the addition of a person with a connection in the family tree. For example, you can't choose to add a grandfather the second family tree if there is no father already added. Thus, if both a father and grandfather are available for merging to the second family tree, and the user only selects the grandfather to merge, then the system will may automatically also select the father to create a complete lineage chain.

Process 600 at block 610 may include generating mappings for persons and families that will be updated based on the request to merge data. For example, objects associated with a person in the second family tree may be updated with objects from a found person in a first family tree. In some implementations, new objects for the person in the second family tree can be added from the objects form a found person in the first family tree.

Process 600 at block 615 may include generating correction data for close family members for persons that will be updated in the second family tree. For example, for a person in the second family tree that will received new or updated objects, this may include generating new child information (add a missing child, replace a wrongly identified child), replace an existing spouse (e.g., due to a divorce), add new spouse information, etc.

As also shown in FIG. 6, process 600 at block 620 may include creating new family member entries in the second family tree for persons that will be newly added in the second family tree. In some implementations, this block 620 is for found persons from the first family tree that will be added to the second family tree when the persons do not already exist in the second family tree. Process 600 at block 625 may include copying objects from the first family tree to the second family tree for persons that were newly added to the second family tree.

Process 600 at block 630 may include correcting immediate or close family members and their related information objects of the persons that are to be merged. For example, for a found person that is to be merged from the first family tree to the second family tree, processor 705 may also update close relatives of the person in the second family tree. For example, the close relatives that may receive updated objects from the first family tree may include, but are not limited to, a spouse/partners, children, parents, parents-in-law.

Process 600 at block 635 may include copying information objects of updated persons in the second family tree and storing the copied information. As also shown in FIG. 6, process 600 at block 640 may include marking merge data as completed for the family tree. In some implementations, this avoids the hold or pending status that is checked in process 400 at block 415.

Process 600 at block 645 may include transmitting an updated display of the second family tree to a remote client to display to the user.

Although FIG. 6 shows example blocks of process 600, in some implementations, process 600 may include additional blocks, fewer blocks, different blocks, or differently arranged blocks than those depicted in FIG. 6. Additionally or alternatively, two or more of the blocks of process 600 may be performed in parallel.

FIG. 7 illustrates an example computer system 700 for executing client or server operations. For example, the example computer system 700 may execute a client application, a server side application for performing the instant disclosure (e.g., a genealogy system).

The example computer system 700 includes a processor 705, a memory 710, a graphical subsystem 715, a network i/o 720, general i/o 725, and a storage 730 that communicate and operate via a connection 735. The connection 735 can be a physical connection via a bus, or a direct connection into processor 705, such as in a chipset architecture. The connection 735 can also be a virtual connection, networked connection, or logical connection.

The processor 705 reads machine instructions that are loaded into the memory 710 and executes an operating system for executing applications within frameworks provided by the operating system. That is, the processor 705 can include any general-purpose processor and a hardware service or software service, which are stored in memory 710, and configured to control processor 705 as well as a special-purpose processor where software instructions are incorporated into the actual processor design. The processor 705 may be a completely self-contained computing system, containing multiple cores or processors, a bus, memory controller, cache, etc. A multi-core processor may be symmetric or asymmetric.

The processor 705 controls the memory 710 to store instructions, user data, operating system content, and other content that cannot be stored within the processor 705 internally (e.g., within the various caches). The processor 705 may also control a graphical subsystem 715 (e.g., a graphical processor) that outputs graphical content to a display. In some example, the graphical subsystem 715 may be integral within the processor 705. In yet another example, the display may be integral with the computer system 700 (e.g., a laptop, a tablet, a phone, etc.). In some example, the graphical subsystem 715 may be integral with the processor 705 and form an accelerated processing unit (APU).

The graphical subsystem 715 may be optimized to perform floating point operations such as graphical computations, and may be configured to execute other operations in place of the processor 705. For example, controlled by instructions to perform mathematical operations optimized for floating point math. For example, the processor 705 may allocate instructions to the graphical subsystem 715 for operations that are optimized for the graphical subsystem 715. For instance, the graphical subsystem 715 may execute operations related to genealogy searching and matching operations, and vector math. The results may be returned to the processor 705. In another example, the application executing in the processor 705 may provide instructions to cause the processor 705 to request the graphical subsystem 715 to perform the operations. In other examples, the graphical subsystem 715 may return the processing results to another computer system (e.g., distributed computing).

The processor 705 may also control a network i/o 720 for transmitting and receiving data using a plurality of wireless channels and at least one communication standard (e.g., Wi-Fi, Bluetooth®, one or more cellular standards (e.g., 4G, 5G, etc.), or a satellite communication network. The network i/o 720 may wirelessly connect to a network to connect to servers or other service providers. The network i/o 720 may also be connected to a network via a physical (i.e., circuit) connection. The network i/o 720 may also directly connect to local electronic devices using other suitable communication technologies.

The processor 705 may also control an i/o 725 that connects with one or more external devices for communication. The i/o 725 is any suitable interface that forms a communication connection and can be implemented by any suitable interface (e.g., universal serial bus (USB), serial cable, and so forth). In some implementations, the one or more external devices is able to receive data from the i/o 725 to process the data or perform functions for different applications executing in the processor 705. For example, the external device may be another display device, a musical instrument, a computer interface device (e.g., a keyboard, a mouse, etc.), an audio device (e.g., an analog-to-digital converter (ADC), a digital-to-analog converter (DAC)), a storage device for storing content, an authentication device, an external network interface, a printer, and so forth.

The storage 730 can be a non-volatile memory device and can be a hard disk or other types of computer readable media which can store data that are accessible by a computer, such as flash memory, solid state memory devices, an electro-mechanical data storage such as a hard disk drive (HDD), optical storage medium, cartridges, random access memories (RAMs), read only memory (ROM), and/or some combination of these devices. However, when mentioned, non-transitory computer-readable storage media expressly exclude media such as energy, carrier signals, electromagnetic waves, and signals per se.

The storage 730 can include software services, servers, services, etc., that when the code that defines such software is executed by the processor 705, it causes the system to perform a function. In some implementations, a hardware service that performs a particular function can include the software component stored in a computer-readable medium in connection with the necessary hardware components, such as processor 705, external devices, etc., to carry out the function.

It should be appreciated that the forgoing improved search, matching, and merging techniques are technological improvements to computing systems enabling faster and more efficient genealogy systems for end users. It should be appreciated that the forgoing improved search, matching, and merging techniques can also be applied in fields other than genealogy records to improve the searching and matching large volumes of data records.

Clause 1. A method of operating a genealogy system, comprising: storing one or more family trees created by users; selecting a stored family tree for matching analysis; selecting a person from the stored family tree and information associated with the person for matching analysis; creating indexing information for the person for the matching analysis; comparing indexing information for the person against indexing information for one or more other persons from other stored family trees for matching analysis; determining one or more potential matching persons from other family trees that meet threshold matching qualifications to modify the selected stored family tree; providing the user with the one or more potential matching persons to select for updating the stored family tree; updating the stored family tree with any selected potential matching persons that the user selected; and transmitting, to a remote client, an updated family tree based on the stored family tree.

Clause 2. A method of operating a genealogy system, comprising: storing one or more family trees created by users; selecting a family tree from the stored one or more family trees for matching analysis preparation; generating unique name tokens for at least one person in the selected family tree based on names associated with the one or more persons; generating tokenized facts mappings for at least person in the selected family tree; generating tokenized relations mapping for at least one person in the selected family tree; storing the generated unique name tokens, tokenized facts mappings, and the tokenized relations mappings for the at least one person; providing the generated unique name tokens, tokenized facts mappings, and the tokenized relations mappings for matching against at least one of a generated unique name token, tokenized facts mapping, or a tokenized relations mapping of at least one other person from a different family tree; and transmitting, to a remote client, one or more potential matching persons to select for updating the stored family tree.

Clause 3. The method of operating the genealogy system of clause 2, wherein the unique name tokens are created based on a quantity of letters in a word and a combination of one or more consonants in a word.

Clause 4. The method of operating the genealogy system of clause 2, further comprising creating a plurality of unique name tokens for one object associated with a person.

Clause 5. A method of operating a genealogy system, comprising: selecting a family tree from a plurality of stored family trees for matching analysis; selecting a person in the selected family tree; determining if the selected person is available for a matching analysis; determining if the selected person has an associated status of pending or hold; determining whether a quantity of prior match results for the selected person is below a predetermined threshold; determining the quantity of matches that remain available to create for the selected person; obtaining any stored prior determined match results for the selected person; removing any stored prior determined match results for the selected person that determined from the family tree; generating potential matches to other persons from other family trees for the selected person based on name tokens and generate a name score for the potential matches; generating a fact score for the potential matches based on comparing facts of the potential matches to facts associated with the selected person; generating a relationship score for the potential matches based on comparing relationships of the potential matches to relationships associated with the selected person; calculating a total score of the potential matches based on the name score, fact scores, and relationship scores for the potential matches; storing potential matches based on the total scores; determining whether there are new relations to add to the selected family tree based on the matches; and storing a predetermined quantity of matches for the selected person in the selected family tree.

Clause 6. A method of operating a genealogy system, comprising: receiving a request to open a user's family tree for display; loading stored match results for any persons in the user's family tree; transmitting the requested family tree to the user, wherein the transmitting provides an indication of at least one person in the requested family tree with at least one potential match to review; enabling the user to select the at least one person in the requested family tree with the at least one potential match for review; receiving from the user, a selection of the at least one person to review the at least one potential match; rechecking the selected at least one person and the at least one potential match to confirm that matching information is still valid; transmitting at least one of changes and additions from the at least one potential match that can be applied to the selected at least one person; determining that the user accepted the at least one potential match to update to the selected family tree; executing a merge process to update the selected family tree with the information associated with the at least one potential match; and transmitting to the user an updated selected family tree based on information associated with the at least one potential match.

Clause 7. The method of operating the genealogy system of clause 6, further comprising: providing a plurality of potential matches for the selected person in the selected family tree; determining that the user rejected one of the plurality of potential matches for the selected person in the selected family tree; and marking the rejected one of the plurality of potential matched to prevent the at least one potential match from being provided to the user at a future time for the selected family tree.

Clause 8. A method of operating a genealogy system, comprising: receiving a request to merge data from a first family tree to a second family tree; generating mappings for persons and families that will be updated based on the request to merge data; generating correction data for close family members for persons that will be updated in the second family tree; creating new family members in the second family tree for persons that will be updated in the second family tree; updating close family members for persons that will be updated in the second family tree; copying information from the first family tree to the second family tree for persons and families that were updated; storing the copied information with the second family tree; and transmitting an updated display of the second family tree to a remote client.

Clause 9. The method of operating the genealogy system of clause 8, further comprising: if a person from a first family tree that will be added to the second family tree and the person does not exist in the second family tree, creating a new entry for the person in the second family tree.

Clause 10. A system for operating a genealogy system comprising: one or more processors configured to: store one or more family trees created by users; select a stored family tree for matching analysis; select a person from the stored family tree and information associated with the person for matching analysis; create indexing information for the person for the matching analysis; compare indexing information for the person against indexing information for one or more other persons from other stored family trees for matching analysis; determine one or more potential matching persons from other family trees that meet threshold matching qualifications to modify the selected stored family tree; provide the user with the one or more potential matching persons to select for updating the stored family tree; update the stored family tree with any selected potential matching persons that the user selected; and transmit, to a remote client, an updated family tree based on the stored family tree.

Clause 11. A system for operating a genealogy system comprising: one or more processors configured to: store one or more family trees created by users; select a family tree from the stored one or more family trees for matching analysis preparation; generate unique name tokens for at least one person in the selected family tree based on names associated with the one or more persons; generate tokenized facts mappings for at least person in the selected family tree; generate tokenized relations mapping for at least one person in the selected family tree; store the generated unique name tokens, tokenized facts mappings, and the tokenized relations mappings for the at least one person; provide the generated unique name tokens, tokenized facts mappings, and the tokenized relations mappings for matching against at least one of a generated unique name token, tokenized facts mapping, or a tokenized relations mapping of at least one other person from a different family tree; and transmit, to a remote client, one or more potential matching persons to select for updating the stored family tree.

Clause 12. The system of clause 11, wherein the unique name tokens are created based on a quantity of letters in a word and a combination of one or more consonants in a word.

Clause 13. The system of clause 11, wherein the one or more processors are further configured to: create a plurality of unique name tokens for one object associated with a person.

Clause 14. A system for operating a genealogy system comprising: one or more processors configured to: select a family tree from a plurality of stored family trees for matching analysis; select a person in the selected family tree; determine if the selected person is available for a matching analysis; determine if the selected person has an associated status of pending or hold; determine whether a quantity of prior match results for the selected person is below a predetermined threshold; determine the quantity of matches that remain available to create for the selected person; obtain any stored prior determined match results for the selected person; remove any stored prior determined match results for the selected person that determined from the family tree; generate potential matches to other persons from other family trees for the selected person based on name tokens and generate a name score for the potential matches; generate a fact score for the potential matches based on comparing facts of the potential matches to facts associated with the selected person; generate a relationship score for the potential matches based on comparing relationship of the potential matches to relationships associated with the selected person; calculate a total score of the potential matches based on the name score, fact scores, and relationship scores for the potential matches; store potential matches based on the total scores; determine whether there are new relations to add to the selected family tree based on the matches; and store a predetermined quantity of matches for the selected person in the selected family tree.

Clause 15. A system for operating a genealogy system comprising: one or more processors configured to: receive a request to open a user's family tree for display; load stored match results for any persons in the user's family tree; transmit the requested family tree to the user, wherein the transmitting provides an indication of at least one person in the requested family tree with at least one potential match to review; enable the user to select the at least one person in the requested family tree with the at least one potential match for review; receive from the user, a selection of the at least one person to review the at least one potential match; recheck the selected at least one person and the at least one potential match to confirm that matching information is still valid; transmit at least one of changes and additions from the at least one potential match that can be applied to the selected at least one person; determine that the user accepted the at least one potential match to update to the selected family tree; execute a merge process to update the selected family tree with the information associated with the at least one potential match; and transmit to the user an updated selected family tree based on information associated with the at least one potential match.

Clause 16. The system of clause 15, wherein the one or more processors are further configured to: provide a plurality of potential matches for the selected person in the selected family tree; determine that the user rejected one of the plurality of potential matches for the selected person in the selected family tree; and mark the rejected one of the plurality of potential matched to prevent the at least one potential match from being provided to the user at a future time for selected family tree.

Clause 17. A system for operating a genealogy system comprising: one or more processors configured to: receive a request to merge data from a first family tree to a second family tree; generate mappings for persons and families that will be updated based on the request to merge data; generate correction data for close family members for persons that will be updated in the second family tree; create new family members in the second family tree for persons that will be updated in the second family tree; update close family members for persons that will be updated in the second family tree; copy information from the first family tree to the second family tree for persons and families that were updated; store the copied information with the second family tree; and transmit an updated display of the second family tree to a remote client.

Clause 18. The system of clause 17, wherein the one or more processors are further configured to: if a person from a first family tree that will be added to the second family tree and the person does not exist in the second family tree, create a new entry for the person in the second family tree.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations have been described. Various modifications may be made without departing from the spirit and scope of the description. For example, various forms of the flow charts shown above may be used, with steps re-ordered, added, or removed. Accordingly, other implementations are within the scope of the following claims.

What is claimed:

1. A method of operating a genealogy system, comprising:
storing one or more family trees created by users;
selecting a family tree from the stored one or more family trees for matching analysis preparation;
generating unique name tokens for at least one person in the selected family tree based on names associated with the one or more persons;
generating tokenized facts mappings for at least person in the selected family tree;
generating tokenized relations mapping for at least one person in the selected family tree;
storing the generated unique name tokens, tokenized facts mappings, and the tokenized relations mappings for the at least one person;
providing the generated unique name tokens, tokenized facts mappings, and the tokenized relations mappings for matching against at least one of a generated unique name token, tokenized facts mapping, or a tokenized relations mapping of at least one other person from a different family tree; and
transmitting, to a remote client, one or more potential matching persons to select for updating the stored family tree.

2. The method of operating the genealogy system of claim 1, wherein the unique name tokens are created based on a quantity of letters in a word and a combination of one or more consonants in a word.

3. The method of operating the genealogy system of claim 1, further comprising creating a plurality of unique name tokens for one object associated with a person.

4. A system for operating a genealogy system comprising:
one or more processors configured to:
store one or more family trees created by users;
select a family tree from the stored one or more family trees for matching analysis preparation;
generate unique name tokens for at least one person in the selected family tree based on names associated with the one or more persons;
generate tokenized facts mappings for at least person in the selected family tree;
generate tokenized relations mapping for at least one person in the selected family tree;
store the generated unique name tokens, tokenized facts mappings, and the tokenized relations mappings for the at least one person;
provide the generated unique name tokens, tokenized facts mappings, and the tokenized relations mappings for matching against at least one of a generated unique name token, tokenized facts mapping, or a tokenized relations mapping of at least one other person from a different family tree; and
transmit, to a remote client, one or more potential matching persons to select for updating the stored family tree.

5. The system of claim 4, wherein the unique name tokens are created based on a quantity of letters in a word and a combination of one or more consonants in a word.

6. The system of claim 4, wherein the one or more processors are further configured to:
create a plurality of unique name tokens for one object associated with a person.
